(19) United States
(12) Patent Application Publication
(10) Pub. No.: US 2026/0175176 A1
(43) Pub. Date: Jun. 25, 2026

(54) SPIRAL MEMBRANE ELEMENT AND METHOD FOR PRODUCING THE SAME

(71) Applicant: NITTO DENKO CORPORATION, Ibaraki-shi (JP)

(72) Inventors: Yasuhiro UDA, Ibaraki-shi (JP); Shinichi CHIKURA, Ibaraki-shi (JP); Maya KIHARA, Ibaraki-shi (JP); Seigo OGAWA, Ibaraki-shi (JP)

(21) Appl. No.: 19/423,708

(22) Filed: Dec. 17, 2025

(30) Foreign Application Priority Data
Dec. 24, 2024 (JP) 2024-227044

(51) Int. Cl. B01D 63/10; B01D 65/00; B01D 71/48

(52) U.S. Cl. CPC B01D 63/101; B01D 65/003; B01D 71/48

(57) ABSTRACT

A spiral membrane element includes: a plurality of membrane leaves each having a permeation-side spacer interposed between separation membranes facing each other and having both-side sealing parts and a peripheral-side end that seal both-side ends in an axial direction; a supply-side spacer interposed between the membrane leaves; and a perforated central pipe around which the membrane leaves and the supply-side spacers are wound, wherein a folded part of an inner surface of each of the membrane leaves and a peripheral-side tip of the permeation-side spacer are not fixed to each other in at least one the peripheral-side end.

### BACKGROUND OF THE INVENTION

### Field of the Invention

The present invention relates to a spiral membrane element capable of easily recovering a member with relatively little contamination (for example, a permeation-side spacer and a central pipe) even after contamination of a member on a feed water side has progressed after long-term use, and a method for producing the spiral membrane element.

### Description of the Related Art

A typical structure of a spiral membrane element includes a plurality of membrane leaves each having a permeation-side spacer interposed between separation membranes facing each other and having both-side sealing parts and a peripheral-side sealing part that seal both-side ends and a peripheral-side end in an axial direction, a supply-side spacer interposed between the membrane leaves, and a perforated central pipe (also referred to as a “water collecting pipe”) around which the membrane leaves and the supply-side spacers are wound. Usually, three sides of the permeation-side spacer are sealed with an adhesive, and the separation membranes are bonded to both surfaces of the permeation-side spacer. At the peripheral-side ends of the respective membrane leaves, the ends of the separation membranes facing each other are adhesively bonded to each other, and the peripheral-side end of the permeation-side spacer is disposed inside the ends to form the peripheral-side sealing part.

Such a spiral membrane element deteriorates in performance over time as a result of deterioration over time and contamination of a membrane surface and the like due to its use. The performance of the membrane surface can be recovered to a certain extent by increasing a supply liquid-side flow rate according to flushing cleaning to physically wash contaminants on the membrane surface or by chemically cleaning the membrane surface according to chemical cleaning. However, since the recovery is limited, the membrane element itself needs to be replaced.

A method for treating a used membrane element after replacement has a major problem, and landfill disposal has a problem because the volume of a treatable site is finite, and a membrane element most of which is a plastic material is not decomposed in the ground and thus semi-permanently remains in the ground. Therefore, it is desired to reduce waste caused by the used membrane element as much as possible. The same applies to a case where incineration disposal is performed.

Meanwhile, when the incineration disposal is performed, CO₂ which is a greenhouse gas is discharged, and thus there is a problem in terms of the global environment.

The membrane element is made of a plastic material derived from crude oil, which is a valuable fossil resource. The used element can also be said to be a valuable carbon resource. It is required to recycle the used element into the plastic material.

As techniques for reusing a used membrane element, for example, there are a structure in which an exterior member of a spiral membrane element can be reused (Patent Documents 1 to 2), a structure in which an anti-telescoping device can be reused (Patent Document 3), a structure in which a central pipe can be reused (Patent Document 4), and the like.

However, in any of these techniques, the structure of the spiral membrane element needs to be changed from the conventional structure, and the used spiral membrane element that has been used so far cannot be reused.

Meanwhile, Patent Document 5 proposes, as a method for reusing a used spiral membrane element having a conventional structure, a method in which a separation functional layer of an RO membrane element is removed with an acid aqueous solution or the like and reproduced into a UF membrane which is a porous support. However, in the reproducing method described in Patent Document 5, the used spiral membrane element cannot be reproduced as the same RO membrane element as that before reproduction, and thus the function of the original separation membrane cannot be restored.

### PRIOR ART DOCUMENT

### Patent Document

Patent Document 1: JP-A-2000-15063

Patent Document 2: JP-A-2012-183527

Patent Document 3: JP-A-2008-149322

Patent Document 4: JP-A-11-267467

Patent Document 5: JP-A-11-156169

### SUMMARY OF THE INVENTION

A permeation-side constituent member is in contact with permeated water after filtration, and thus is relatively less contaminated even in the membrane element after use. For example, even if the permeation-side spacer is to be recovered as a recycled material, the permeation-side spacer is located inside the adhesively sealed membrane leaves, and thus the separation operation is very troublesome. Although it is possible to manually take out the permeation-side spacers one by one, it is very troublesome and the operation cost also increases. Therefore, it is required to easily disassemble the used membrane element and to easily recover the permeation-side spacer for material recycling.

Therefore, an object of the present invention is to provide a spiral membrane element that can reduce waste caused by a used spiral membrane element and save resources to be introduced and can easily recover a permeation-side spacer by changing peripheral-side ends of membrane leaves to a structure that is easy to disassemble, and a method for producing the spiral membrane element.

The above object can be achieved by the present invention as described below.
[1] A spiral membrane element including: a plurality of membrane leaves each having two separation membranes facing each other, a permeation-side spacer provided therebetween, both-side sealing parts that seal both-side ends of the two separation membranes and the permeation-side spacer in an axial direction (A1), and a peripheral-side end parallel to the axial direction (A1) of the separation membranes and the permeation-side spacer; a supply-side spacer interposed between the membrane leaves adjacent to each other; and a perforated central pipe around which the membrane leaves and the supply-side spacers are wound, wherein
a folded part of an inner surface of each of the membrane leaves and a peripheral-side tip of the permeation-side spacer are not fixed to each other in at least one the peripheral-side end.

Here, the “folded part of the inner surface of each of the membrane leaves” includes a folded form of a continuous separation membrane and a form in which the peripheral-side end is a peripheral-side sealing part.
[2] The spiral membrane element according to [1], wherein the folded part of the inner surface of each of the membrane leaves is formed by folding a continuous separation membrane.
[3] The spiral membrane element according to [1] or [2],
wherein at least one (preferably one) peripheral-side end of the plurality of membrane leaves constitutes a first peripheral-side sealing part in which ends of the separation membranes and the peripheral-side tip of the permeation-side spacer are sealed (with an adhesive), or
constitutes a second peripheral-side sealing part in which ends of the separation membranes are sealed (with an adhesive) without being fixed to the peripheral-side tip of the permeation-side spacer.
[4] The spiral membrane element according to [2], wherein the continuous separation membrane is wound around the central pipe and has a fold position such that an outer separation membrane distal from the central pipe is longer than an inner separation membrane proximal to the central pipe.
[5] The spiral membrane element according to [2], further including a protective member that is brought into contact with a folded part of the continuous separation membrane.
[6] The spiral membrane element according to [5], wherein the protective member has a central part (brought into contact with a folding position) having rigidity smaller than that of other portion.
[7] The spiral membrane element according to [3], wherein the permeation-side spacer in the membrane leaf having the first peripheral-side sealing part has a tear processing part over the entire width (for example, in a direction parallel to the central pipe) on a peripheral side from the center (for example, at a position closer to the peripheral-side sealing part than to the central pipe).
[8] The spiral membrane element according to [1], wherein all the peripheral-side ends of the plurality of membrane leaves constitute a peripheral-side sealing part in which ends of the separation membranes are sealed (with an adhesive) except for the permeation-side spacer.
[9] A method for producing a spiral membrane element according to any one of [2] to [7],
the method comprising:
a folded separation membrane forming step of forming a zigzag with one separation membrane, interposing a supply-side spacer between the folded separation membranes, and forming j-th folded separation membranes (j=1 to n);
a permeation-side spacer preparing step of fixing a first permeation-side spacer positioned at a lowermost portion at the start of a winding operation and a plurality of i-th (i=2 to n) permeation-side spacers wound from a position above the first permeation-side spacer (for example, by fusion bonding or an adhesive) along a longitudinal direction (width direction) of a central pipe;
a membrane leaf forming step of sequentially sandwiching the j-th separation membrane having the supply-side spacer interposed between the i-th permeation-side spacer and an (i+1)-th permeation-side spacer, to form a plurality of membrane leaves each having a permeation-side spacer interposed between the separation membranes facing each other and having both-side sealing parts and a peripheral-side end that seal both-side ends in an axial direction (A1);
a peripheral-side sealing part forming step of sealing ends of the separation membranes together with or excluding a peripheral-side tip of the permeation-side spacer (for example, with an adhesive) to form a peripheral-side sealing part; and
a winding step of winding the membrane leaves around the central pipe (using, for example, a double-sided tape, fusion, an adhesive, or the like provided on a surface of the i-th permeation-side spacer in contact with the central pipe) for fixing.

The peripheral-side sealing part forming step may be performed at the time of the winding step or may be performed after the winding step.
[10] The method for producing a spiral membrane element according to [9], further including the step of providing a protective member at a position to be a fold portion of the separation membrane (except for the separation membrane of the peripheral-side end to be the peripheral-side sealing part) before or during the folded separation membrane forming step.
[11] A method for decomposing a spiral membrane element according to any one of [1] to [8] and collecting a permeation-side spacer and a central pipe, the method including the steps of:
cutting a roll of the used spiral membrane element in a radial direction so as to remove both-side sealing parts or cutting off other member (permeation-side spacer, separation membrane, and supply-side spacer) with the central pipe left;
(optionally) removing both-end membrane bundle bonding parts from an intermediate water collecting part of the central pipe; and
removing a peripheral-side sealing part of membrane leaves after cut-off to separate the separation membranes and the supply-side spacers from the central pipe with the permeation-side spacer left.
[12] The method according to [11], further including the step of removing an exterior member (FRP) when the exterior member (FRP) is provided around the outer periphery of the used spiral membrane element.
(1) According to the spiral membrane elements of [2] and [3], by forming many membrane leaves with the continuous separation membrane and reducing the peripheral-side sealing part, the operation of taking out the permeation-side spacer from the used membrane element can be minimized.
(2) According to the spiral membrane element of [4], the continuous separation membrane is wound around the central pipe, and the fold position is adjusted such that the outer separation membrane distal from the central pipe is longer than the inner separation membrane proximal to the central pipe, and thus when each of the membrane leaves is wound around the central pipe, the occurrence of creases in the separation membrane can be suppressed.
(3) According to the spiral membrane elements of [5] and [6], it is possible to protect the fold portion and stabilize the folding position. Since the folding position of the peripheral-side sealing part of the membrane leaf is stabilized, the spiral membrane elements are easily produced. When wound, the membrane leaf is less likely to wrinkle as a whole.
(4) According to the spiral membrane element of [7], the tear processing part is formed in the vicinity of the peripheral-side sealing part of the permeation-side spacer. Therefore, by pulling the peripheral-side sealing part of the membrane leaf from which both-side sealing parts have been removed or the separation membrane in a direction away from the central pipe, the tear processing part is torn, and the separation membrane and the supply-side spacer can be easily separated from the central pipe with the permeation-side spacer left.
(5) According to the spiral membrane element of [8], the separation membranes are bonded to each other except for the permeation-side spacer in the peripheral-side sealing part, so that the separation membrane and the supply-side spacer can be easily separated from the central pipe with the permeation-side spacer left by hooking and winding the peripheral-side sealing part or the separation membrane of the membrane leaf.
(6) It is possible to minimize the contamination of the permeation-side spacer due to the dismantling operation, and thus, the permeation-side spacer is suitable for use as a raw material for material recycling or chemical recycling.

### BRIEF DESCRIPTION OF THE DRAWINGS

FIG. 1A is partially exploded perspective view illustrating a membrane element of a first embodiment;

FIG. 1B is a perspective view illustrating a main part obtained by cutting out a part of the membrane element of the first embodiment;

FIG. 1C is a view illustrating the membrane element of the first embodiment and a modification thereof;

FIG. 1D is a view illustrating an example of a protective member at the tip of a membrane leaf;

FIG. 1E is a view illustrating a membrane element of a second embodiment and a modification thereof;

FIG. 2A is a plan view illustrating an example of a step of cutting off both-side sealing parts;

FIG. 2B is a development view illustrating an example of a step of cutting off both-side sealing parts, which shows one of membrane leaves in a developed state;

FIG. 3A is a development view illustrating an example of a tear processing part, which shows one of membrane leaves in a developed state;

FIG. 3B is a schematic view illustrating an example of a perforation processing part as an example of the tear processing part;

FIG. 3C is a schematic view illustrating an example of a half cut processing part as an example of the tear processing part;

FIG. 4A is a view illustrating an example of a method for producing the membrane element of the first embodiment;

FIG. 4B is a view illustrating an example of a method for producing the membrane element of the first embodiment;

FIG. 5A-FIG.5C are schematic views illustrating an example of a division structure of the central pipe; and

FIG. 6 illustrates an example of a plan cross-sectional view of a membrane element.

### DETAILED DESCRIPTION OF THE PREFERRED EMBODIMENTS

### Spiral Membrane Element

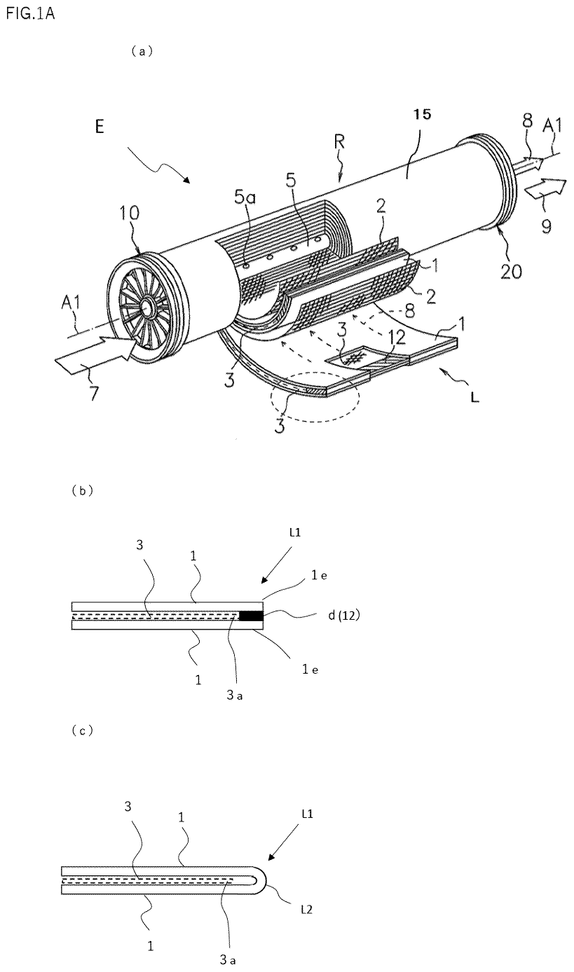

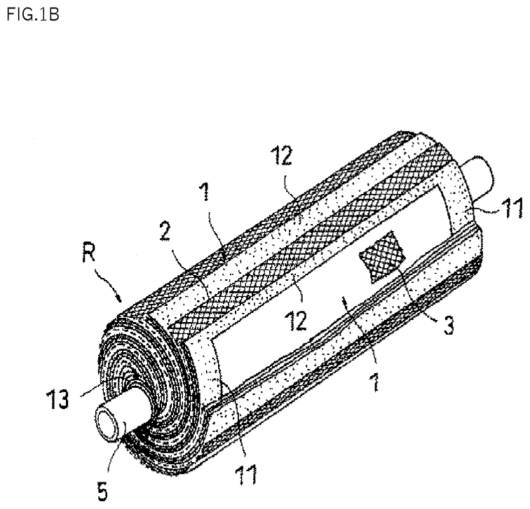

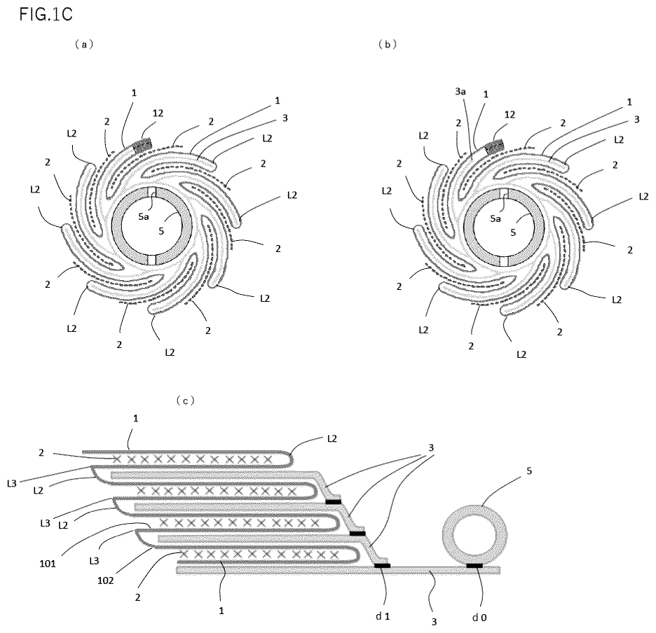

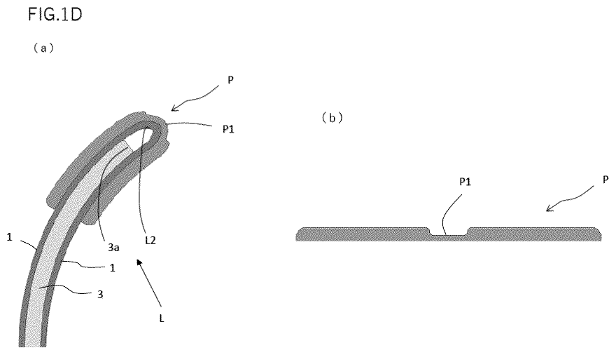

As illustrated in FIGS. 1A and 1B, a spiral membrane element E of the present invention (hereinafter, simply referred to as a “membrane element E”) includes a plurality of membrane leaves L each having a permeation-side flow-channel between two separation membranes 1 facing each other, and a perforated central pipe 5 around which the membrane leaves L are wound with a supply-side flow-channel interposed between the membrane leaves L. Usually, the permeation-side flow-channel is formed by a permeation-side spacer 3, and the supply-side flow-channel is formed by a supply-side spacer 2. In a first embodiment, in the membrane leaf L, the two separation membranes 1 and the permeation-side spacer 3 form both-side sealing parts 11 in which both-side ends in an axial direction (A1) are sealed with an adhesive. As illustrated in FIG. 1A(b), in one of peripheral-side ends L1 parallel to the axial direction (A1) of the separation membrane 1 and permeation-side spacer 3, ends 1e and 1e of the two separation membranes 1 facing each other and a peripheral-side tip 3a of the permeation-side spacer 3 are fixed with an adhesive d to constitute a peripheral-side sealing part 12. As illustrated in FIG. 1A(c), other than the configuration illustrated in FIG. 1A(b) in the peripheral-side end L1, a folded part L2 of the inner surface of the membrane leaf L and the peripheral-side tip 3a of the permeation-side spacer 3 are not fixed to each other.

Both sides of an end of the permeation-side spacer 3 facing the peripheral-side sealing part 12 are directly fixed to the central pipe 5 with an adhesive so as to avoid at least openings 5a.

In this specification, the membrane leaves L and the supply-side spacers 2 wound around the central pipe 5 are referred to as a roll R, and the membrane element E generally has a structure including an exterior member 15 around the outer periphery of the roll R as illustrated in FIG. 1A(a). The used membrane element is referred to as a used membrane element UE.

The membrane element E is provided with both-side sealing parts 11, a peripheral-side sealing part 12, and a folded part L2 as sealing parts for preventing mixing of a supply-side flow-channel and a permeation-side flow-channel. As illustrated in FIG. 1B, the both-side sealing parts 11 are obtained by using an adhesive to seal two side ends on both sides in the axial direction A1 of each of the membrane leaves L. The peripheral-side end L1 of one membrane leaf L constitutes the peripheral-side sealing part 12, and the other peripheral-side end L1 constitutes the folded part L2. An internal area of the membrane leaf L serves as the permeation-side flow-channel. This communicates with the openings 5a of the central pipe 5.

In the present invention, as illustrated in FIG. 1B, the membrane element includes a central-side sealing part 13 obtained by using an adhesive to seal the perforated (5a) central pipe 5 and a base end of each of the membrane leaves L. In this example, the membrane element includes the roll R in which the membrane leaf L and the supply-side spacers 2 are wound around the central pipe 5 with such a central-side sealing part 13 interposed therebetween. The adhesive is not particularly limited, and any conventionally known adhesive such as a urethane-based adhesive or an epoxy-based adhesive can be used.

In the general membrane element E, as illustrated in FIG. 1A(a), an upstream-side end member 10 such as a seal carrier is provided on the upstream side of the roll R, and a downstream-side end member 20 such as an anti-telescoping device is provided on the downstream side. The upstream-side end member 10 and the downstream-side end member 20 may be integrated with the roll R by winding FRP serving as the exterior member 15 around the outer periphery of the roll R.

In a typical spiral membrane element having a diameter of 8 inches, about 15 to 30 sets of membrane leaves L are wound. When the membrane element E is used, the membrane element E is accommodated in a pressure vessel (vessel), and a supply liquid 7 is supplied from one end surface side of the membrane element E.

As illustrated in FIG. 1A(a), the supplied supply liquid 7 flows along the supply-side spacers 2 into a direction parallel with the axial direction A1 of the central pipe 5, and is then discharged as a concentrated liquid 9 from the other end surface side of the membrane element E. In the process in which the supply liquid 7 flows along the supply-side spacers 2, a permeation liquid 8 which has permeated through the separation membranes 1 flows along the permeation-side spacers 3, then flows into the central pipe 5 from the openings 5a, and is discharged from the end of the central pipe 5.

The supply-side spacer 2 generally has a function of ensuring spaces, the spaces being for uniformly supplying a fluid onto a membrane surface. The supply-side spacer 2 may be, for example, a net, a knitted fabric, or a sheet worked to have irregularities. Such a spacer that has a maximum thickness of about 0.1 to 3 mm can be appropriately used if necessary. The spacer is set on each of both surfaces of the separation membrane 1. Two different flow-channel members are generally used: one thereof is used, on the supply liquid side, as the supply-side spacer 2, and the other is used, on the permeation liquid side, as the permeation-side spacer 3. In the supply-side spacer 2, a thick network flow-channel member having large meshes is used, and in the permeation-side spacer 3, a woven fabric or knitted fabric flow-channel member having fine meshes is preferably used.

As illustrated in FIG. 1A(a), the central pipe 5 only needs to have a pipe wall having the openings 5a, and any conventional central pipe can be used. In general, in the case of use in seawater desalination, wastewater treatment or the like, permeated water that has permeated through the separation membrane 1 flows toward the central pipe 5 in the permeation-side flow-channel formed along the permeation-side spacer 3 interposed between the separation membranes 1 facing each other, then flows into the central pipe 5 from the openings 5a, flows in the central pipe 5, and is discharged from the end.

When an RO membrane or an NF membrane is used in applications such as seawater desalination and wastewater treatment, the permeation-side spacer 3 is interposed between the separation membranes 1 facing each other in the membrane leaves L as illustrated in FIG. 1A. The permeation-side spacer 3 is required to support the separation membranes 1 from the back sides of the membranes against pressure applied to the separation membranes 1, and further to ensure flow-channels for permeation liquid.

In order to ensure such a function, the permeation-side spacer 3 is preferably formed of a tricot knitted fabric, and more preferably a tricot knitted fabric subjected to resin impregnation reinforcement or fusion treatment after the formation of the knitted fabric. A warp knitting material such as tricot half knitting or double Denby knitting of a polyester material is used.

As the separation membrane 1, various porous membranes can be used, but a composite semipermeable membrane including a separation functional layer on the surface of a porous support is preferable. The porous support preferably includes a polymer porous layer on one surface of a nonwoven fabric layer.

Such a composite semipermeable membrane is called an RO (reverse osmosis) membrane, an NF (nano-filtration) membrane, or an FO (forward osmosis) membrane depending on the filtration properties or treatment methods, and is usable for the production of ultrapure water, seawater desalination, desalinization of brackish water, and reuse of wastewater and the like.

Examples of the exterior member 15 include various sheets, films, and tapes, and if necessary, a fiber reinforced resin (FRP) or the like is used for reinforcement. In a structure in which the upstream-side end member 10 and the downstream-side end member 20 are firmly integrated by the exterior FRP, it is difficult to disassemble and collect the upstream-side end member 10 and the downstream-side end member 20. However, by cutting off the both-side sealing parts 11 at the time of recycling, these members are easily separated and collected.

### First Embodiment: Folded Form of Continuous Separation Membrane

As described above, in FIG. 1A(b), in one membrane leaf L, the ends 1e and 1e of the two separation membranes 1 facing each other and the peripheral-side tip 3a of the permeation-side spacer 3 disposed therebetween are fixed with the adhesive d to constitute the peripheral-side sealing part 12. In FIG. 1A(c), the folded part L2 is composed of a continuous separation membrane 1, and has a structure in which the inner surface of the folded part L2 and the peripheral-side tip 3a of the permeation-side spacer 3 are not fixed to each other, that is, are not sealed with an adhesive or the like. FIG. 1C(a) illustrates a schematic view of a state where the membrane leaf L and the supply-side spacer 2 are wound around the central pipe 5. Both ends of the permeation-side spacer 3 in contact with central pipe 5 are fixed with the adhesive d.

The continuous separation membrane 1 was repeatedly folded to form the membrane leaf L, and the permeation-side spacer 3 interposed between the separation membranes 1 facing each other and the inner surface of the folded part L2 were not fixed, so that only one peripheral-side sealing part 12 was provided. As a result, when the permeation-side spacer 3 and the central pipe 5 are recycled, it is only necessary to cut one peripheral-side sealing part 12 after cutting the both-side sealing parts 11, and it is not necessary to cut all the peripheral-side sealing parts 12 formed on all the membrane leaves L as in the conventional case, so that the cutting operation can be minimized.

### Modification of Folded Form

FIG. 1C(b) is a modification of FIG. 1C(a). In all the folded parts L2, the inner surface of the folded part L2 and the peripheral-side tip 3a of the permeation-side spacer 3 are not fixed to each other. Furthermore, in peripheral-side sealing part 12, the peripheral-side tip 3a of the permeation-side spacer 3 is not fixed, that is, is not sealed with an adhesive or the like.

### Form of Fold Position

FIG. 1C(c) illustrates a schematic view of a state before the membrane leaf L and the supply-side spacer 2 are wound around the central pipe 5. The continuous separation membrane 1 is wound around the central pipe 5 and has fold positions L3 such that an outer separation membrane 102 distal to the central tube 5 is longer than an inner separation membrane 101 proximal to the central pipe 5.

The continuous separation membrane 1 is wound around the central pipe 5, and the fold positions L3 are adjusted such that the outer separation membrane 102 distal from the central pipe 5 is longer than the inner separation membrane 101 proximal to the central pipe 5, so that when each of the membrane leaves L is wound around the central pipe 5, the occurrence of creases in the separation membrane can be suppressed.

### Protection of Folded Part

FIG. 1D(a) illustrates a protective member P that is brought into contact with the folded part L2 of the continuous separation membrane 1.

The protective member P is configured to have, for example, a smaller thickness than that of other portion so that the rigidity of a central part P1 brought into contact with a fold is smaller than that of the other portion (see FIG. 1D(b)). By making the rigidity of the central part P1 smaller than that of the other portion, the protective member P can follow the shape of the folded part L2, and by attaching the protective member P to the fold portion, the folding position can be stabilized.

The protective member P may be, for example, the same material as that of the resin film or the separation membrane.

### Second Embodiment: Folded Form of Peripheral-Side Sealing Part

As illustrated in FIG. 1E(a), in one membrane leaf L, ends 1e and 1e of two separation membranes 1 facing each other and a peripheral-side tip 3a of a permeation-side spacer 3 disposed therebetween are fixed with an adhesive d to constitute a first peripheral-side sealing part 121.

As illustrated in FIG. 1E(b), except for the membrane leaf L illustrated in FIG. 1E(a), a folded part L2 of the other membrane leaf L is configured as a second peripheral-side sealing part 122 in which only ends 1e and 1e of separation membranes 1 facing each other are fixed with an adhesive d. Unlike FIG. 1A(b) and 1E(a), a peripheral-side tip 3a of a permeation-side spacer 3 interposed between the separation membranes 1 facing each other is not fixed with the adhesive d. FIG. 1E(c) illustrates a schematic view of a state where the membrane leaf L and a supply-side spacer 2 are wound around a central pipe 5.

As a result, when the permeation-side spacer 3 and the central pipe 5 are recycled, it is only necessary to cut only the first peripheral-side sealing part 121 fixed to the permeation-side spacer 3 after cutting both-end sealing parts 11, and it is not necessary to cut all the peripheral-side sealing parts formed on all the membrane leaves L as in the conventional case, so that the cutting operation can be minimized.

### Modification of Second Embodiment

In a second embodiment, as illustrated in FIG. 1E(b), folded parts L2 of all membrane leaves L are configured as a second peripheral-side sealing part 122 in which ends 1e and 1e of separation membranes 1 facing each other are fixed with an adhesive d. FIG. 1E(d) illustrates a schematic view of a state where a membrane leaf L and a supply-side spacer 2 are wound around a central pipe 5.

Consequently, a first peripheral-side sealing part 121 fixed to a permeation-side spacer 3 is also absent, so that the operation can be further simplified.

### Third Embodiment

In the first and second embodiments, a tear processing part may be provided in a permeation-side spacer 3 of peripheral-side sealing parts 12 and 121 fixed together with a peripheral-side end 3a of the permeation-side spacer 3.

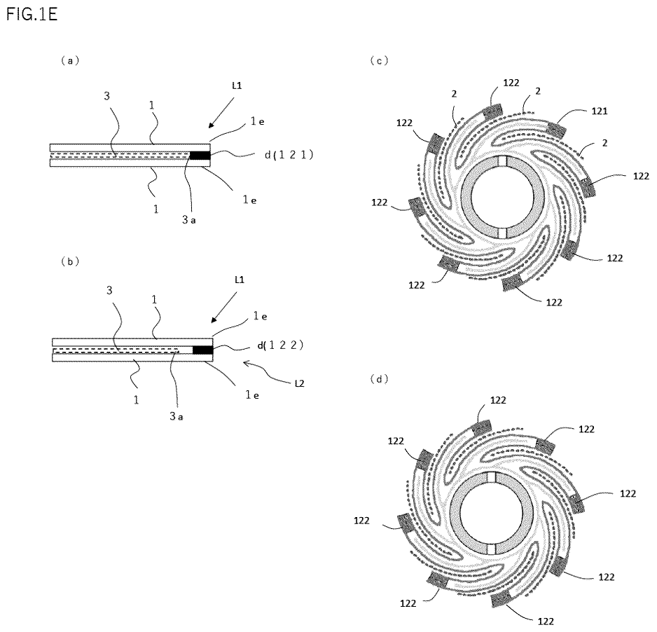

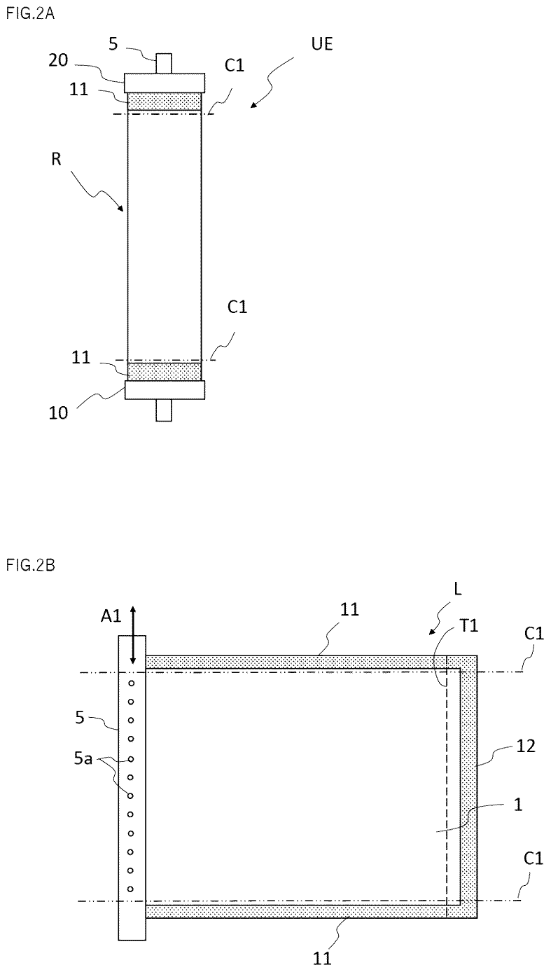

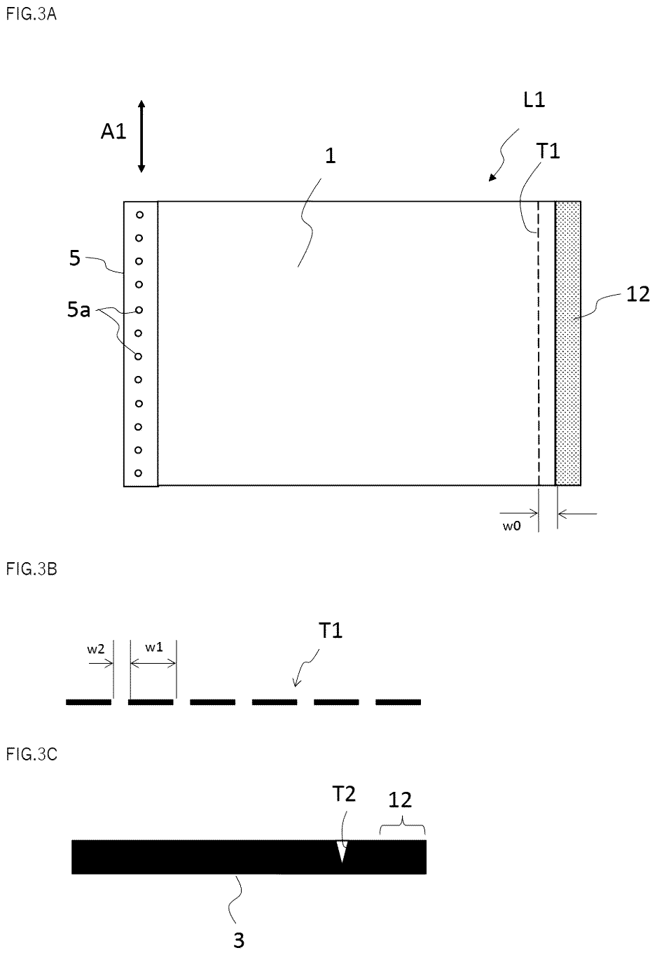

In the permeation-side spacer 3 in a membrane leaf L, a tear processing part T1 is formed over the entire width (direction of a central pipe 5) on a peripheral side from the center (at a position closer to the peripheral-side sealing parts 12 and 121 than to the central pipe 5). In FIGS. 2B and 3A, a perforation processing part is indicated by a broken line as an example of the tear processing part T1. The perforation processing part illustrated in FIG. 3B has a cut length w1 of 10 mm to 100 mm and a cut interval w2 of 0.5 mm to 3 mm. When the cut length w1 is less than 10 mm or the interval w2 exceeds 3 mm, the tearability of the permeation-side spacer is deteriorated. When the cut length w1 exceeds 100 mm, the firmness and rigidity of the permeation-side spacer are lowered, which makes it difficult to handle the permeation-side spacer at the time of assembly. When the interval w2 is less than 0.5 mm, the permeation-side spacer may be ruptured at the time of assembly or use.

As illustrated in FIG. 3A, the position of the tear processing part T1 is set such that a distance w0 from the peripheral-side sealing parts 12 and 121 toward the central pipe 5 is 10 mm to 100 mm, preferably 10 mm to 80 mm, more preferably 10 mm to 60 mm, and still more preferably 10 mm to 50 mm. When the distance w0 is less than 10 mm, the tear processing part T1 is too close to the peripheral-side sealing parts 12 and 121, so that the tear processing part T1 may interfere with adhesive application processing. When the distance w0 exceeds 100 mm, the area of the reusable permeation-side spacer decreases.

### Another Example of Tear Processing Part

A tear processing part T2 in FIG. 3C is a half cut part. The half cut part has a cut depth of 50% to 95% of the thickness of the permeation-side spacer. When the cut depth is less than 50%, the tearability of the permeation-side spacer is deteriorated, and when the cut depth exceeds 95%, the permeation-side spacer may be ruptured during assembly or use. The position of the tear processing part T2 is the same as the distance w0 described above.

### Producing Method of First Embodiment

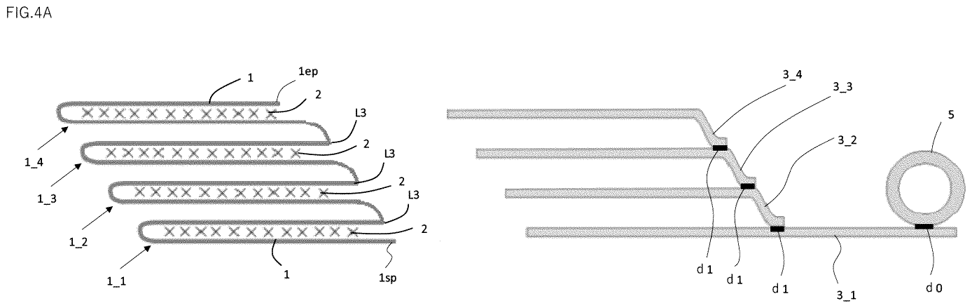

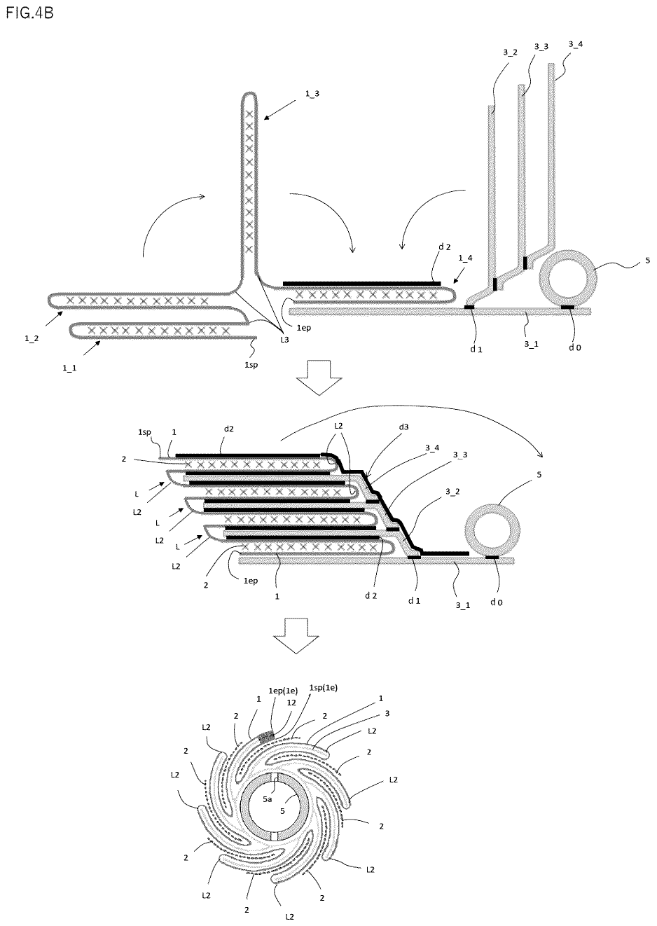

A method for producing a spiral membrane element includes the following steps. Here, one separation membrane 1 constitutes a plurality of membrane leaves L. Each step is exemplified in FIGS. 4A and 4B.
(S1) A zigzag is formed with one separation membrane 1. The separation membrane 1 is folded distally from an end 1sp of the separation membrane 1 as a starting point to form a first folded separation membrane 1_1. Then, a fold (fold position L3 described above) is formed, and the separation membrane 1 is folded distally again to form a second folded separation membrane 1_2. Similarly, in repeating fashion, a third folded separation membrane 1_3 and a fourth folded separation membrane 1_4 are formed. The end of the separation membrane 1 as an end point is indicated as 1ep. A supply-side spacer 2 is interposed inside each of the first, second, third, and fourth folded separation membranes 1_1, 1_2, 1_3, and 1_4.

That is, the j-th folded separation membranes 1_j (j=1 to n) are formed by interposing the supply side spacer 2 between the separation membranes 1 folded at every other position (folded separation membrane forming step). In FIG. 4A, the number of the folded separation membranes is 4(j).
(S2) A first permeation-side spacer 3_1 positioned at the lowermost portion at the start of the winding operation and a plurality of i-th permeation-side spacers 3_i (i=2 to n) wound from positions above the first permeation-side spacer 3_1 are fixed along the longitudinal direction (width direction) of a central pipe 5 (permeation-side spacer preparing step). In FIG. 4A, four (=i) configurations of the permeation-side spacers 3 are exemplified in accordance with the number of folds of 4 of the separation membrane 1. Both ends of the first permeation-side spacer 3_1 in a direction orthogonal to an axial direction (A1) are fixed to the central pipe 5 by a connecting part d0. The first permeation-side spacer 3_1 and a second permeation-side spacer 3_2; the second permeation-side spacer 3_2 and a third permeation-side spacer 3_3; and the third permeation-side spacer 3_3 and a fourth permeation-side spacer 3_3 are fixed by connecting parts d1 in a direction parallel to the axial direction (A1). By the connecting part d0, the members are fixed to each other by, for example, a double-sided tape, fusion (for example, ultrasonic fusion, heat fusion, and the like), and the like. By the connecting parts d1, the members are fixed to each other by, for example, an adhesive, fusion (for example, ultrasonic fusion, heat fusion, and the like), and the like.
(S3) A j-th separation membrane 1_j with the supply-side spacer 2 interposed is sequentially sandwiched between an i-th permeation-side spacer 3_i and an (i+1)-th permeation-side spacer 3_i+1, and the permeation-side spacer 3 is interposed between the separation membranes 1 facing each other to form a plurality of membrane leaves L each having a both-side sealing part 11 and a peripheral-side end L1 (folded part L2 and one peripheral-side sealing part 12) that seal both-side ends in the axial direction (A1) (membrane leaf forming step).

In FIG. 4B, a first permeation-side spacer 3_1 is set on its side so as not to interfere with other permeation-side spacers, and a fourth folded separation membrane 1_4 is stacked on the first permeation-side spacer 3_1. Subsequently, an adhesive d2 is applied to both-side ends of the fourth folded separation membrane 1_4 in a direction orthogonal to the axial direction (A1) of the first permeation-side spacer 3_1, and a second permeation-side spacer 3_2 is stacked to form both-side sealing parts 11. The same operation handling is repeated, and an adhesive d3 is applied to both-side ends of the first, second, third, and fourth permeation-side spacers 3_1, 3_2, 3_3, and 3_4 in the direction orthogonal to the axial direction (A1) at positions facing the central pipe 5 in order to fix the stack of the formed membrane leaves around the central pipe 5. The adhesive d2 applied to both-side ends of the uppermost separation membrane and the adhesive d3 applied to both-side ends of the fourth permeation-side spacer 3_4 may be connected to each other.
(S4-1) Ends 1ep and 1sp of one separation membrane 1 are sealed with an adhesive together with or except for a peripheral-side tip 3a of the permeation-side spacer 3 to form a peripheral-side sealing part 12 (peripheral-side sealing part forming step). In FIG. 4B, the peripheral-side sealing part 12 is sealed together with the peripheral-side tip 3a of the permeation-side spacer 3 with an adhesive. In the modification of the first embodiment (FIG. 1A(b)), the peripheral-side sealing part 12 is configured to seal only the ends 1ep and 1sp of one separation membrane 1 with an adhesive. FIG. 4B(S4) illustrates an example of eight membrane leaves L.
(S4-2) The membrane leaf L is wound around the central pipe 5, and fixed by the adhesive d3 provided at both-side ends in the direction orthogonal to the axial direction (A1) of the i-th permeation-side spacer 3_i in contact with the central pipe 5 (winding step). FIG. 4B illustrates a side cross section of the membrane element wound around the central pipe 5.

The peripheral-side sealing part forming step may be performed at the time of the winding step or may be performed after the winding step.

### Protective Member Attaching Step

In the folded separation membrane forming step (S1) or before the folded separation membrane forming step (S1), the protective member P is applied (attached) to the fold portion of the separation membrane. For example, the protective member P is attached to a fold portion when a zigzag is formed with one separation membrane. This makes it possible to prevent the occurrence of damage in the fold portion of the separation membrane when the operation of folding the separation membrane is performed. By making the rigidity of the central part of the protective member P smaller than that of the other portion, the position of the fold can be stabilized when the separation membrane is folded.

### Method for Recovering Reproduced Member

A method for recovering a reproduced member is a method for disassembling the used membrane element UE and recovering the permeation-side spacer and the central pipe.
(S11) (S11) is a step of removing the exterior member 15 when the exterior member 15 is provided around the outer periphery of the used membrane element UE.
(S12) (S12) is a step of cutting the roll R of the used membrane element UE in a radial direction so as to remove the both-side sealing parts 11, or cutting off other members (permeation-side spacer 3, separation membranes 1, and supply-side spacers 2) with the central pipe 5 left.
(S13) (S13) is a step of (optionally) removing both-end membrane bundle bonding parts 600 from an intermediate water collecting part 610.
(S14) The peripheral-side sealing part 12 of the membrane leaf L after cut-off is removed, and the separation membrane 1 and the supply side spacer 2 are separated from the central pipe 5 with the permeation-side spacer 3 left.

### Step of Cutting Off Both-Side Sealing Parts: S12

FIG. 2A is a plan view illustrating an example of a step of cutting off the both-side sealing parts 11, and FIG. 2B is a development view illustrating an example of a step of cutting off the both-side sealing parts 11, which shows one of membrane leaves L in a developed state.

The both-side sealing parts 11 usually include the two separation membranes 1 facing each other and the permeation-side spacer 3 interposed therebetween and are fixed with an adhesive. In this step, as illustrated in FIG. 2A, it is preferable to cut off both-side ends of the supply-side spacer 2 in the axial direction A1 on the center side from the both-side sealing parts 11 when cutting off the both-side sealing parts 11.

As illustrated in FIG. 3A, the membrane leaf L1 is obtained in which the two separation membranes 1 facing each other and the permeation-side spacer 3 are bonded to each other only by the peripheral-side sealing part 12 among the sealing parts at the three side ends of the membrane leaf L. At this time, one or more membrane leaves L1 may be fixed (bonded or the like) to the central pipe 5 via the permeation-side spacer 3. Also, when both-side ends of the supply-side spacer 2 are cut off, the length of the supply-side spacer 2 in the axial direction A1 can be made equal to the length of the permeation-side spacer 3.

In this step, it is sufficient that at least the both-side sealing parts 11 are cut off from the main body of the used membrane element UE, and the end of the central pipe 5, the upstream-side end member 10, or the downstream-side end member 20 may be simultaneously cut off. That is, it is also possible to leave the ends without cutting the central pipe 5. In the present embodiment, an example is shown in which the both-side sealing parts 11, the both-side ends of the central pipe 5, the upstream-side end member 10, and the downstream-side end member 20 are cut off.

Examples of the method for cutting off the both-side sealing parts 11 include a method for removing both ends of the roll R including the both-side sealing parts 11 and both ends of the central pipe 5 from the main body of the used membrane element UE by cutting at a cutting line C1, a method for separating both ends of the roll R including the both-side sealing parts 11 from the main body of the used membrane element UE by cutting only the roll R without cutting the central pipe 5, and the like. Simultaneously or separately from these methods, it is also possible to remove the upstream-side end member 10 and the downstream-side end member 20. A method for removing the entire both ends of the roll R including the both-side sealing parts 11 by cutting or the like may be used.

The width at the time of cutting off the both-side sealing parts 11 of the used membrane element UE is preferably 50 mm or less based on the length of the separation membrane 1 in the axial direction A1. In addition, it is preferable that the length of the separation membrane 1 after cut-off is 87% or more of the length before cut-off, based on the length of the separation membrane 1 before cut-off in the axial direction A1.

### Removal of Peripheral-Side Sealing Part: S14

When there is one peripheral-side sealing part 12 to which the separation membrane 1 is fixed, the separation membrane 1 and the supply-side spacer 2 may be separated from the central pipe 5 while the permeation-side spacer 3 left after the peripheral-side sealing part is cut off.

When the tear processing part T1 is formed in the permeation-side spacer 3, the tear processing part T1 may be torn by hooking and winding the peripheral-side sealing part 12 or the separation membrane 1 fixed to the peripheral-side sealing part 12 to separate the separation membrane 1 and the supply-side spacer 2 from the central pipe 5 with the permeation-side spacer 3 left.

### Separation

After collecting the separation membrane, the peripheral-side sealing parts (ends of two separation membranes, end of permeation-side spacer, and composite part of sealing resin), and the supply-side spacer, the process proceeds to a chemical recycling process by thermal decomposition. In order to proceed to the process of thermal decomposition, it is preferable to separate the supply-side spacer suitable for thermal decomposition and other materials not suitable for thermal decomposition (separation membrane, permeation-side spacer, sealing resin) by pretreatment.

Examples of the pretreatment include a step of crushing the collected members and a step of separating the members by a difference in specific gravity using an aqueous solution. For example, since the specific gravity of the material of the supply-side spacer is light (for example, polypropylene resin: about 0.9, polyethylene resin: about 0.95) and the specific gravity of other material is heavy (for example, polyethylene terephthalate: about 1.6, fiber-reinforced plastic: about 1.8, and urethane resin: about 1.2), the members can be easily separated and collected by using an aqueous solution (specific gravity: about 1.05) whose specific gravity is adjusted after chopping. Furthermore, when centrifugal separation is performed by a fluid cyclone, the separation can be advanced quickly and efficiently.

### Another Embodiment of Step of Cutting Off Both-Side Sealing Parts

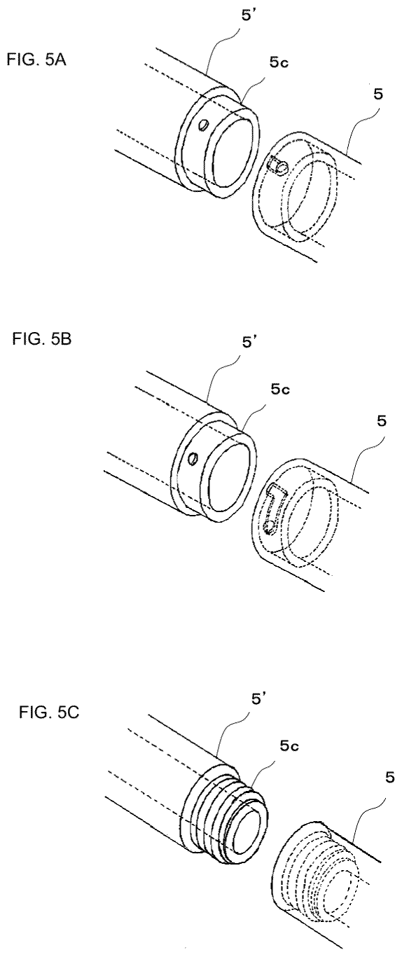

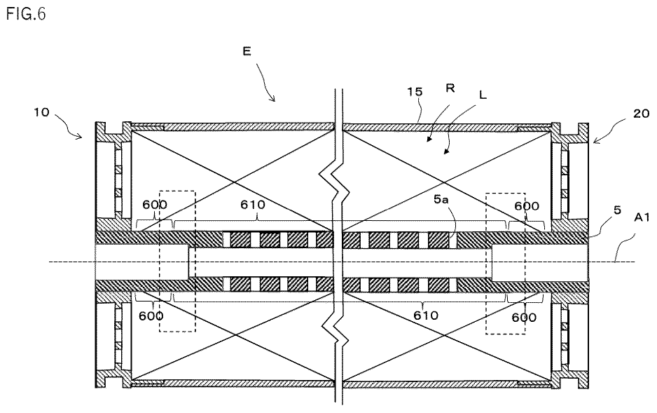

The central pipe 5 illustrated in FIGS. 5 and 6 has a structure that can be divided at both ends in a longitudinal direction. FIG. 6 illustrates a cross-section of a plane of the membrane element E. A broken line frame in FIG. 6 indicates a boundary between both-end membrane bundle bonding parts 600 and an intermediate water collecting part 610, and a fitting part in FIG. 5 is provided here. By adopting a structure in which the both-end membrane bundle bonding parts 600 and the intermediate water collecting part 610 are connected by fitting, the both-side sealing parts 11 can also be divided at a cutting position. The fitting part does not require a seal, such as an adhesive. When the roll is wound up at the time of producing the membrane element, torque acts on the central pipe 5, so that the fitting part has a whirl-stop mechanism in the circumferential direction. Specifically, the fitting part can be configured by a latch mechanism that can be fastened only by pushing using the elasticity of the material of the central pipe, a mechanism in which a rotating operation is added to the latch mechanism, or screw fastening or the like.

FIGS. 5A to 5C illustrate examples of the fitting structure of the central pipe 5. In the example illustrated in FIG. 5A, a fitting connection part 5c of an end-side central pipe 5′has a protrusion, and the main body of the central pipe 5 has a guide groove and a recess. Therefore, the fitting connection part 5c can be pushed to lock the protrusion to the recess for fixing.

In the example illustrated in FIG. 5B, the fitting connection part 5c of the end-side central pipe 5′has a protrusion, and the main body of the central pipe 5 has an L-shaped guide groove and a recess. Therefore, when the fitting connection part 5c is pushed and rotated so that the protrusion follows the guide groove, the protrusion can be locked to the recess for fixing.

In the example illustrated in FIG. 5C, the fitting connection part 5c of the end-side central pipe 5′has a male screw structure and the main body of the central pipe 5 has a female screw structure. Therefore, the fitting connection part 5c can be rotated and screwed.

According to the present invention, the permeation-side spacer and the central pipe can be efficiently recovered from the used membrane element. It is possible to minimize the contamination of the permeation-side spacer due to the dismantling operation, and thus, the permeation-side spacer can be used as raw materials for material recycling or chemical recycling.

What is claimed is:

1. A spiral membrane element comprising:
a plurality of membrane leaves each having a permeation-side spacer interposed between separation membranes facing each other and having both-side sealing parts and a peripheral-side end that seal both-side ends in an axial direction;
a supply-side spacer interposed between the membrane leaves; and
a perforated central pipe around which the membrane leaves and the supply-side spacers are wound,
wherein a folded part of an inner surface of each of the membrane leaves and a peripheral-side tip of the permeation-side spacer are not fixed to each other in at least one the peripheral-side end.

2. The spiral membrane element according to claim 1, wherein the folded part of the inner surface of each of the membrane leaves is formed by folding a continuous separation membrane.

3. The spiral membrane element according to claim 1,
wherein
at least one peripheral-side end of the plurality of membrane leaves constitutes a first peripheral-side sealing part in which ends of the separation membranes and the peripheral-side tip of the permeation-side spacer are sealed, or
constitutes a second peripheral-side sealing part in which the ends of the separation membranes are sealed without being fixed to the peripheral-side tip of the permeation-side spacer.

4. The spiral membrane element according to claim 2, wherein the continuous separation membrane is wound around the central pipe and has a fold position such that an outer separation membrane distal from the central pipe is longer than an inner separation membrane proximal to the central pipe.

5. The spiral membrane element according to claim 2, further comprising a protective member that is brought into contact with a fold part of the continuous separation membrane.

6. The spiral membrane element according to claim 5, wherein the protective member has a central part having rigidity smaller than that of other portion.

7. The spiral membrane element according to claim 3, wherein the permeation-side spacer in the membrane leaf having the first peripheral-side sealing part has a tear processing part over the entire width on a peripheral side from the center.

8. The spiral membrane element according to claim 1, wherein all the peripheral-side ends of the plurality of membrane leaves constitute a peripheral-side sealing part in which ends of the separation membranes are sealed except for the permeation-side spacer.

9. A method for producing a spiral membrane element according to claim 2,
the method comprising:
a folded separation membrane forming step of forming a zigzag with one separation membrane, interposing a supply-side spacer between the folded separation membranes, and forming j-th folded separation membranes;
a permeation-side spacer preparing step of fixing a first permeation-side spacer positioned at a lowermost portion at the start of a winding operation and a plurality of i-th permeation-side spacers wound from a position above the first permeation-side spacer along a longitudinal direction of a central pipe;
a membrane leaf forming step of sequentially sandwiching the j-th separation membrane having the supply-side spacer interposed between the i-th permeation-side spacer and an (i+1)-th permeation-side spacer, to form a plurality of membrane leaves each having the permeation-side spacer interposed between the separation membranes facing each other and having both-side sealing parts and a peripheral-side end that seal both-side ends in an axial direction;
a peripheral-side sealing part forming step of sealing ends of the separation membranes together with or excluding a peripheral-side tip of the permeation-side spacer to form a peripheral-side sealing part; and
a winding step of winding the membrane leaves around the central pipe for fixing.

10. The method for producing a spiral membrane element according to claim 9, further comprising the step of providing a protective member at a position to be a fold portion of the separation membrane before or during the folded separation membrane forming step.
